(19) United States
(12) Patent Application Publication
(10) Pub. No.: US 2006/0212381 A1
(43) Pub. Date: Sep. 21, 2006

(54) Method of and system for displaying market information

(76) Inventor: Marshall R. Rowe III, Chicago, IL (US)

Correspondence Address: MCCRACKEN & FRANK LLP, 200 W. ADAMS STREET, SUITE 2150, CHICAGO, IL, 60606, US

(21) Appl. No.: 11/084,981

(22) Filed: Mar. 21, 2005

(51) Int. Cl. G06Q 40/00

(52) U.S. Cl. 705/37

(57) ABSTRACT

A method of displaying market information in a market place includes capturing trade information relevant to a trading area using a computer and projecting visual information representative of portions of the captured trade information using one or more laser projectors. The visual information may be projected onto any suitable surface in the line of sight of the laser projectors, and the laser may project onto different display areas on each display surface. The information may be captured with a publication and subscription system and the captured information may be processed to select only certain identified portions of the captured information for display.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates to a method of displaying market information and apparatus therefor.

2. Description of the Background of the Invention

In a marketplace where a plurality of different trade transactions, each including at least two parties, occur at or about the same time for one or more discrete amounts of a similar product, it is helpful to the parties involved in any one of the transactions to have information regarding what agreements other parties have entered regarding other discrete amounts of the same or similar product. For example, in an open outcry market, such as a futures exchange or a commodities exchange, it is customary to have a pit area for each product being traded in a larger room containing several pit areas for several products. In addition, there are customarily one or more fixed area display boards located around the perimeters of the room to display constantly updated trade prices for each of the various products being traded in the room. The display board is often not localized to a specific trading pit because there is no place in or near the pit sufficient to accommodate the display board.

In one method of displaying such market information, an optical image of a continuously updated ticker tape is projected onto a viewing screen. Another method is to locate a large board having a fixed area matrix of light emitting diodes (LED's) for displaying continually updated market information from a market exchange on the walls of the room of a marketplace or in a remote location. Yet another method includes displaying market information on a large area video display system, or video wall, having many individual video screens located along a wall of the room. Each of these methods is constrained to either a limited type or form of market information or to displaying the market information in a limited area defined by a size of the display apparatus and the available wall space.

### SUMMARY OF THE INVENTION

According to one aspect of the invention, a method of displaying real time market information proximate a trading area includes capturing recent trade information and projecting visual information representing a selected portion of the captured trade information from a laser projector onto a display area proximate the trading area.

According to another aspect of the invention, a system for displaying market information includes a publication and subscription system transmitting continually updated transaction data associated with trade transactions, a control computer in data communication with the publication and subscription system, a control program associated with the control computer, and a laser projector in data communication with the control computer. The control program captures selected transaction data from the publication and subscription system and transmits image data relevant to a portion of the selected transaction data to the laser projector. The laser projector projects an image relevant to the image data onto a display area on a display surface.

Other aspects and advantages of the present invention will become apparent upon consideration of the following detailed description, wherein like reference numbers in the various drawings designate like structures in the various embodiments.

### BRIEF DESCRIPTION OF THE DRAWINGS

FIG. 1 is a diagrammatic perspective view of a laser display system displaying market information in a marketplace in a manner according to one aspect of the present invention;

FIG. 2 is a block diagram of one embodiment of the laser display system shown in FIG. 1;

FIG. 3 is a block flow diagram illustrating a method of displaying market data using the laser display system in a manner according to one aspect of the present invention;

FIG. 4 is a logic diagram illustrating steps in a control process for capturing, extracting, and transmitting market data to a laser projector according to one aspect of the present invention; and

FIG. 5 is a graphic user interface display according to one embodiment of the present invention for administering the control process shown in FIG. 4.

### DETAILED DESCRIPTION

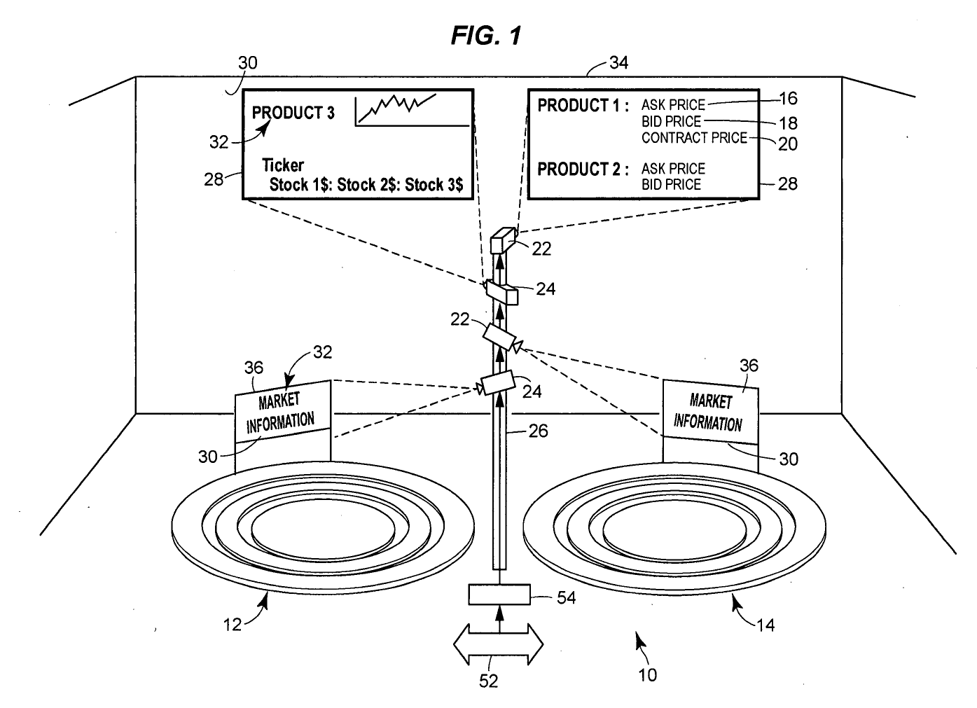

Turning now to the drawings, FIG. 1 shows a marketplace 10 in which lasers are used to project images representing market information for viewing by traders and others in the marketplace. The marketplace 10 may be any type of regulated or monitored market for any type of product. An example of a marketplace 10 is an open outcry commodities futures exchange where traders buy and sell futures contracts for a specified commodity, such as corn or soybeans, in a designated trading area, such as trading pits 12 and 14, by yelling or signaling an offer to sell or buy a contract to all other traders in the pit and coming to an agreement with one of the other traders to buy or sell the contract at an agreed upon contract price. Customarily, each trading pit 12 and 14 is designated for trading a specific one of the commodities. For example, trading pit 12 may be designated for trading futures contracts only for corn, and trading pit 14 may be designated for trading futures contracts only for soybeans. Different contracts are traded for the designated commodity or product in each trading pit 12, 14, such as contracts for different quantities and different closing dates. Other types of marketplaces could include a stock exchange, a bond exchange, a currency exchange, an auction house, a silent or computerized electronic exchange, or any other type of marketplace that monitors and reports on market activity relevant to the products and/or contracts being traded. The market activity that is monitored and reported usually includes raw market data regarding market information, such as current or latest asking price 16 in an offer to sell, latest bid price 18 in an offer to buy, latest settlement or contract price 20, and other market information. Other market information, such as volume of trading activity, running averages, etc., may be derived from the raw market data by various calculations. The market information may be specific to the products traded at the marketplace 10 and may also include market information from marketplaces at other locations.

Laser projectors 22, 24, which are disposed on or about one or more laser projector stands 26 in or near the marketplace 10, display selected portions of the market information represented by or derived from the raw market data in a display area 28 on a display surface 30 in the marketplace 10. In other embodiments, a single laser projector or more than two laser projectors may be used to display market information in the marketplace 10. In one embodiment, the market information displayed by the laser projectors 22, 24 is continually updated from real-time raw market data so that the laser projectors are able to project images 32, including alpha-numeric characters, pictures, graphics, etc., onto the display surfaces 30 that represents the most recent market information. The display surface 30 may be chosen from any surface within a line of sight of the laser projectors 22, 24 that is suitable for reflecting a laser beam to display the images 32 to viewers in and around the trading pits 12, 14 and/or the marketplace 10. In one embodiment, the display surface 30 is a wall 34 common to a plurality of trading pits 12, 14, in which case the images 32 are readily visible from several or all of the trading pits. In another embodiment, the display surface is a display board 36, such as a projector screen or kiosk, either pre-existing or specially constructed, that is near or in a trading pit 12, 14 and is only readily visible by viewers in and around that trading pit. In other embodiments, the display surface may be any flat or curved surface within the line of sight of the laser projectors 22, 24. The display area 28 may be selected from a plurality of available display areas on each display surface 30 by, for example, changing the projection area of the laser projectors 22, 24 by adjusting the focus of a lens or controlling a scanning pattern of the laser projector to make the projection area larger or smaller. In this manner, the laser projectors 22, 24 may be pointed toward any available display surface 30 and adjusted to cover the available display area 28 without creating a specially adapted display surface or display area, and thereby allowing greater flexibility than with a fixed area display system.

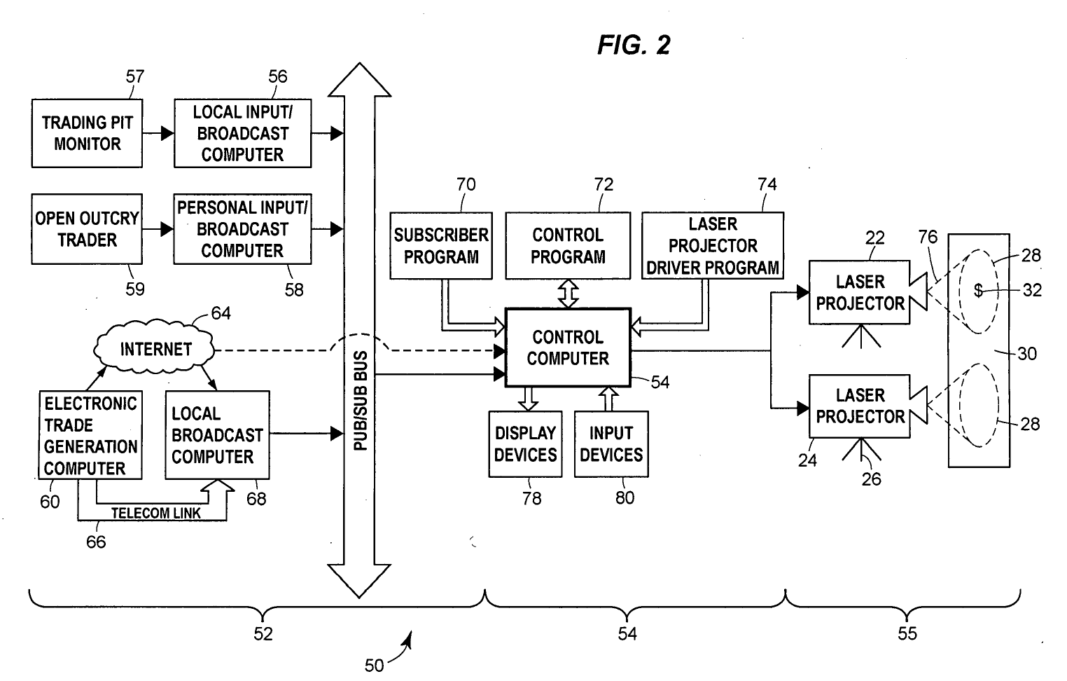

Turning now to FIG. 2, a computer assisted system 50 for displaying market information using the laser projectors 22, 24 includes a source 52 of continually updated raw market data, a control computer 54 linked to the source of raw market data, and one or more laser projection systems 55 linked to the control computer. The source of market data 52 includes a system for gathering raw market data relevant to various categories of market information onto various input computers 56, 58, and/or 60 in an electronic computer readable medium by any convenient method. The raw market data is initially captured by any convenient method, such as, continual manual data entry of open outcry trade transaction information and/or continual electronic monitoring of electronic trade transaction information. In one method, designated monitors 57 monitor market activity at trading pits 12, 14 and manually convert bid, ask, and contract prices 16, 18, and 20 into electronic format, such as at a local input computer 56 located near the trading pit as the trading activity occurs. In another method, an individual trader 59 enters trade contract information, such as the contract price 20 and other contract information, into a personal computer, such as 58, as each trade agreement is made. In another method, a remote or central hub input computer 60 electronically monitors and gathers raw market data regarding electronically generated and matched trade transactions. Other similar and/or effective methods of capturing and transmitting raw market information to a selection and processing device could also be used. The gathered market data is then transmitted, such as by publishing from the input computers 56, 58, and/or 60, to a data pathway, such as a local publication and subscription bus (pub/sub bus) 62, either directly or indirectly via intervening computer assisted systems, the internet 64, or other electronic data transfer mechanisms, such as a telecommunications data link 66 connected to a local publishing computer 68. Other computers connected to the data pathway are able to retrieve or receive the published market data when it is transmitted. In one embodiment, the source 52 of market data includes a computer implemented publication and subscription system (pub/sub system) connected to a multicast transmission system, which collectively gathers, transmits, and receives the market data in a coordinated manner. One such transmission system includes a quote vendor system (QVS) broadcasting market data conforming to Inter-Exchange Technical Committee (ITC) Specification Version 2.1, which may be found at www.cbot.com/cbot/docs/52987.pdf and is expressly incorporated by reference herein. In one embodiment, the transmission system includes a remote sensor connected to a multicast data transmission source and a pub/sub bus. The remote sensor reads data packets from the multicast data transmission source and writes the data packets to the pub/sub bus using an application programming interface (API) such as SMARTSOCKETS software available from Tibco Software, Inc. located at 3303 Hillview Avenue, Palo Alto, Calif. 94304. A complementary subscription program 70 allows the control computer 54, for example, to read the data packets from the pub/sub bus 62. A detailed description of one embodiment of such a transmission system may be found in U.S. patent application Ser. No. 10/992,061, entitled “System and Method for Processing Matched Trades,” and expressly incorporated herein by reference in its entirety. In other embodiments, gathered raw market data may be entered directly into the control computer 54, and, either additionally or alternatively, other systems and methods of providing a source 52 of raw market data and other processed market data to the control computer may be implemented. Other methods and systems apparent to those skilled in the art for transmitting and receiving raw market data may additionally or alternatively be implemented, such as, for example, using wireless broadcasting and receiving systems.

The control computer 54 is subscribed to the pub/sub bus 62 using the subscription program 70 so that the control computer is able to capture, by receiving and/or gathering, the published raw market data from the pub/sub bus. A control program 72 associated with the control computer 54 selects or filters the incoming market data and extracts therefrom only market data relevant to desired market information for display. A laser projector driver program 74 translates the selected market data to be readable by the laser projectors 22, 24 and transmits the translated market data to the laser projectors for displaying the market information with the laser projection system 55. Various other display devices 78, such as a monitor and/or a printer, and input devices 80, such as a mouse and/or an alpha-numeric keyboard, are also connected to the control computer 54 to facilitate user interface with the control computer and the various programs 70, 72, and/or 74 associated therewith.

In each laser projection system 55, the laser projectors 22 and/or 24 project the selected market data by vector scanning, or tracing, a laser beam 76 along the outline of an image 32 representative of the selected market information in the display area 28 on the display surface 30. In one embodiment, the laser projectors 22, 24 vector scan the images 32 at a speed fast enough to cause a normal viewer to see an entire image rather than a moving dot of light, which is typically faster than about 60 Hz. In another embodiment, the laser projectors 22, 24 may raster scan the laser beam 76. In another embodiment, the subscription program 70, the control program 72, and the laser projector driver program 74 may be combined into a single program or other sub-combinations. A program may be any computer implemented system or component—such as hardware, software, firmware, routines, sub-routines, or any portion, combination, or sub-combination thereof—that is adapted to perform the functions associated therewith.

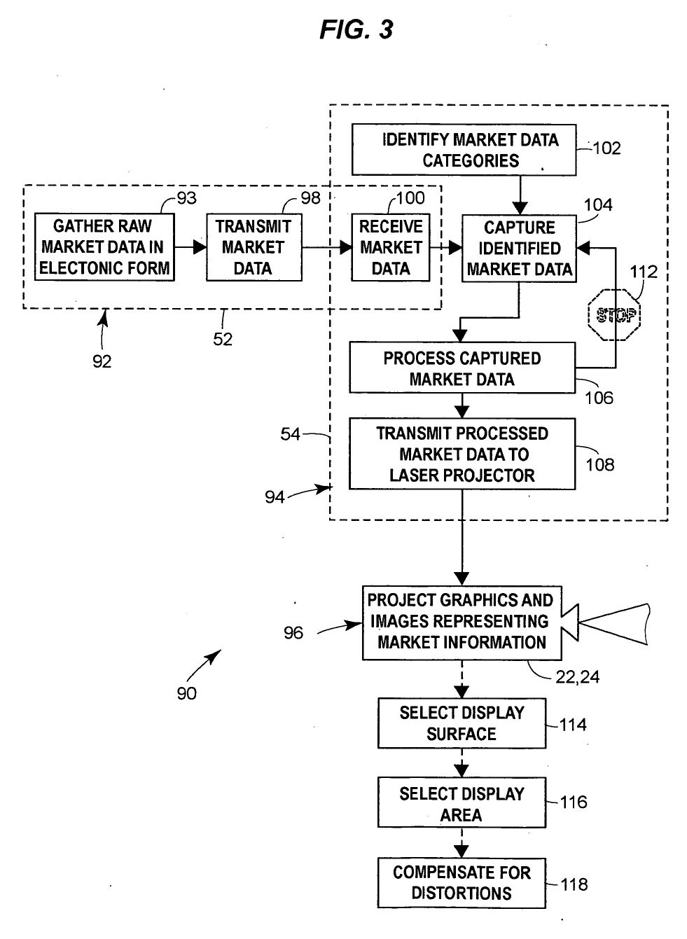

Turning now to FIG. 3, a method 90 of displaying market information using a laser includes capturing 92 raw market data from a trading area, processing 94 the raw market data to obtain data relevant to only selected market information, and projecting 96 images representative of the selected market information onto a display surface proximate to one or more trading areas. One method of capturing 92 the raw market data includes using a source 52 such as the pub/sub system described previously herein to gather 93 raw market data and convert the raw data into a pre-defined or common electronic format. The gathered raw market data are transmitted/broadcast 98, such as via the pub/sub bus 62, in real time. The broadcast raw market data usually include information regarding many trade transactions for many different products or contracts, which may be categorized in many different ways. The broadcast raw market data are captured or received 100 by, for example, the control computer 54 that is subscribed to the pub/sub bus 62 using the subscription program 70, thereby providing continually updated real time raw market data for processing 94.

To begin a session of processing 94, a user selects or identifies 102 one or more market information categories for which market information is to be displayed. Market data relevant to or identified with the identified market information are selected 104 from the captured raw market transaction data, such as with a mask or filtering method or by actively retrieving only selected data that correspond to the selected market information categories. The selected market data are processed 106 into a form and format suitable for display in the marketplace 10. The processed market data are translated into a format readable by the laser projectors and transmitted 108, such as with an appropriate laser projector driver program 74, via any suitable data link to the laser projectors 22, 24 for projection 96 onto the display surface 30 in the display area 28. The steps of selecting 104 and processing 106, and the step of translating and transmitting 108 the market data are continually repeated during a processing session, such as on a pre-determined time frequency or in response to instances of receiving updated data from the pub/sub system 52, until a stop event 112 ends the processing session.

During a processing session, and usually, although not necessarily, at the beginning thereof, optional setup and/or adjustment steps may be taken. A user selects 114 a display location by selecting a display surface 30 from any available suitable surface within a line of sight of the laser projector 22, 24 onto which the laser may be directed and seen. The user then selects 116 a display area 28 on or within boundaries of the display surface 30. For example, as shown in FIG. 1, the display surface 30 may be one of the large walls 34 around the marketplace 10, or the display surface may be one of the small display boards 36 inside or directly adjacent to the trading pits 12, 14, and the display area may be selected from any available display area on the selected display surface. If the user selects a wall that also carries an LED display board (not shown), the user may select a portion of the wall that is not covered by the LED display board. If a plurality of laser projectors 22, 24 is used, each laser projector may be focused on a sub-area adjacent to another sub-area onto which another laser projector is focused. In this situation, each laser projector 22, 24 may project a complete image 32, or each laser projector may project a sub-portion of a larger image. In another embodiment, two or more laser projectors 22, 24 may be focused on the same display area 28 so that, for example, one laser projector 22 scans a first portion of a larger image 32, such as generally static background images, and another laser projector 24 scans another portion of the larger image that overlaps with the first portion, such as rapidly changing or frequently updated market information images. If the selected display surface 30 is angularly disposed or skewed at an angle away from a perpendicular with the laser projector, the user adjusts 118 the projected image from the laser projector to compensate for distortions caused by the skew angle. In one embodiment, the step of adjusting for skew angle is performed with, for example, display controls embedded in either the control program 72 or the laser projector driver program 74. In another embodiment, a user may also adjust the projected images to compensate for distortions caused by a curved display surface. Once an image 32 is adjusted to the user's preference, the setup and adjustment steps 114, 116, and 118 generally do not need to be repeated until the laser projector 22, 24 is moved or a new display surface 30 or display area 28 is selected.

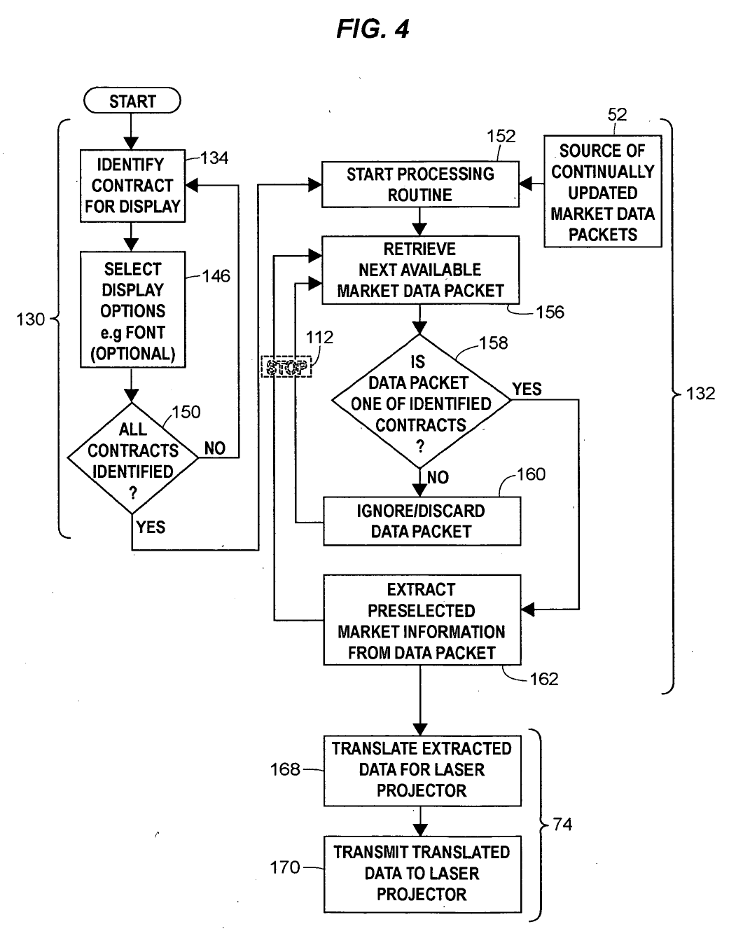

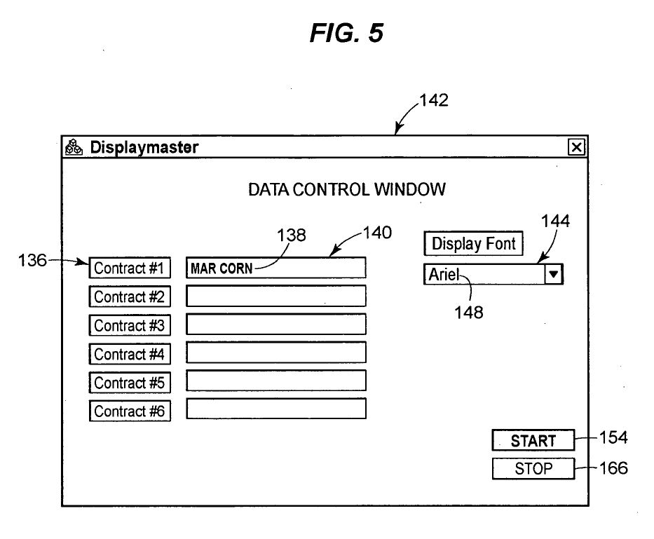

Turning now to FIGS. 4 and 5, one system and method of processing the captured raw market data includes an embodiment of the control program 72, which allows a user to control the market transaction data transmitted to the laser projectors 22, 24 for display. The control program 72 includes an identification routine 130 and a processing routine 132, and provides selected market data to a laser projector drive program 74. The user uses the product identification routine 130 to identify 134 each specific contract 136 for which information is to be displayed by entering a predefined contract name 138 of the contract(s), for example March corn futures contracts, into a first data entry position 140 in a data control window 142 displayed on a display device 78, such as a computer monitor, using an input device 80, such as a mouse or keyboard. The user may also be provided with an additional and optional data entry position 144 to control additional aspects of the displayed image, such as selecting 146 a display font 148 or other aspects of the displayed market information. A decision 150 is then made to either identify 134 additional contracts for display or start 152 the processing routine 132. The identification routine 130 is repeated until all the contracts to be displayed (and optionally the associated font, etc., for each displayed contract) are identified. In another embodiment, the display font 148 may be fixed to a specific font and not be controllable by the user, and other aspects of the specific market information being identified may also be controlled.

After all the contracts to be displayed are identified, the user starts 152 the processing routine 132 by, for example, activating a start button 154 with the mouse or keyboard. The processing routine 132 then begins accepting or retrieving 156 the raw market data supplied from the source 52 of market data by any convenient method, such as by either actively retrieving received market data from a storage location or simply by accepting received market data that is actively transmitted to the control program 72 from the subscriber program 70. In one method, raw data for each market transaction is grouped as a discrete data string, which includes data regarding a plurality of market information categories for that market transaction. Each data string includes an identifier, which identifies the contract type, and data regarding one or more aspects of a trade transaction that has occurred in that contract type. The processing routine 132 then decides whether the retrieved market data is either relevant to one of the identified contracts or not relevant to one of the identified contracts. In one embodiment, the processing routine 132 compares 158 the identifier on each data string to the identified contract names 138 entered in the data entry positions 140. If the data string does not correlate to one of the identified contract names 138, the control program 72 discards or ignores 160 that data string and retrieves or accepts 156 the next data string from the source 52 of raw market data. If the data string correlates to one of the identified contract names 138, the processing routine 132 extracts 162 preselected market data, such as the bid price 18, asking price 16, and/or contract price 20, from the data string and provides the extracted market information to the laser projector driver program 74. The processing routine 132 then retrieves or accepts 156 the next data string from the source 52 of raw market data and continues in like manner until the processing routine is ended or stopped 112 by, for example, activating a stop button 166, exiting the control program 72, or simply turning off the control computer 54. In one embodiment, the laser projector driver program 74 accepts the extracted market data from the control program 72, translates 168 the extracted market data to a format that is readable by the laser projector(s) 22, 24, and transmits 170, or otherwise makes available, the translated market data to the laser projector(s) 22, 24 for projecting 96 one or more images 32 representative of the identified market information for viewing. Other driver programs for different laser projectors may include additional or different processing methods for providing the extracted market data to the laser projectors in a manner suitable for the projectors to use to project images relevant to the identified market data.

Other steps and systems may be added to the basic method and system described herein to display other market information. In one embodiment, the processing program 72 may be able to receive, or include a routine to calculate derived market information, such as trading volume, running averages, graphs, charts, a scrolling stock ticker, notices, news, messages, etc. for display by the laser projectors 22, 24. In another embodiment, the processing program 72 may accept data from additional data feed sources, such as the internet 64 for processing and display in the marketplace 10. In another embodiment, additional programs may be installed on the control computer 54 to provide additional information for display by the laser projectors.

### INDUSTRIAL APPLICATION

The method of displaying market information using a laser and the laser display system of the present invention can be used to display market information in a marketplace or other area where market information is displayed. The system and method of the present invention are advantageous because of the flexibility regarding where the market information is displayed and how big or small it is displayed. This flexibility allows, for example, a marketplace that already has LED display boards completely full with market information to display additional market information on a small portion of wall adjacent to an LED display board without being constrained by the amount of space available or having to buy and install a new LED display board. The system and method of the present invention also provides greater flexibility regarding what market information is displayed and how it is displayed, such as, for example, displaying both graphs and a ticker, or updating static image portions more slowly than updating changing image portions.

The invention has been described in an illustrative manner in order to enable a person of ordinary skill in the art to make and use the invention, and the terminology used is intended to be in the nature of description rather than of limitation. It is understood that the invention may be practiced in ways other than as specifically described, and that all modifications, equivalents, and variations of the present invention, which are possible in light of the above teachings and ascertainable to a person of ordinary skill in the art, are specifically included within the scope of the impending claims.

I claim:

1. A method of displaying real time market information proximate a trading area comprising the steps of:
capturing recent trade information relevant to the trading area using a computer;
projecting visual information representing a selected portion of the captured trade information from a laser projector in communication with the computer onto one of a plurality of different sized display areas proximate the trading area.

2. The method of claim 1, wherein the step of capturing includes identifying at least one of a plurality of information categories.

3. The method of claim 2, wherein the step of capturing further includes retrieving only data relevant to the identified information categories from a source of data relevant to a plurality of information categories.

4. The method of claim 3, wherein the step of capturing further includes subscribing the computer to a publication and subscription bus.

5. The method of claim 4, wherein the step of capturing further includes publishing transaction data regarding trades made at an open-outcry trading area to the publication and subscription bus.

6. The method of claim 1, wherein the suitable display areas are disposed on any one of a plurality of display surfaces proximate the trading area.

7. The method of claim 6, wherein the one display area is substantially within the trading area.

8. The method of claim 6, wherein the one display area is substantially outside the trading area.

9. The method of claim 8, wherein the one display area is readily visible from the trading area and from a second trading area.

10. The method of claim 9, wherein the one display surface is a wall proximate the first-recited trading area and the second trading area.

11. The method of claim 9, wherein the step of capturing includes capturing recent trade information relevant to the second trading area using the computer.

12. The method of claim 6, wherein the one display surface is substantially flat.

13. The method of claim 1, wherein the step of projecting includes adjusting the laser projector to compensate for a skew angle between the laser projector and the one display area.

14. The method of claim 1, wherein the step of projecting includes vector scanning a laser associated with the laser projector along an image of the visual information at a speed sufficient to allow a person to see the entire image.

15. The method of claim 14, wherein the image is a substantially static graphic.

16. The method of claim 14, wherein the step of projecting includes projecting a first portion of the visual information from the first-recited laser and projecting a second portion of the visual information from a second laser.

17. The method of claim 15, wherein the first portion of the visual information is projected onto a first portion of the one display area and wherein the second portion of the visual information is projected onto a second portion of the one display area.

18. The method of claim 17, wherein the first portion of the one display area is adjacent to the second portion of the one display area.

19. The method of claim 14, wherein the step of projecting includes scanning each of a plurality of portions of the visual information with a different one of a corresponding plurality of laser projectors.

20. A system for displaying market information comprising:
a publication and subscription system transmitting continually updated transaction data associated with a plurality of products and a plurality of trade transactions for each product;
a control computer in data communication with the publication and subscription system;
a control program associated with the control computer;
a laser projector in data communication with the control computer;
the control program identifying and capturing selected transaction data from the publication and subscription system and transmitting image data relevant to at least a portion of the selected transaction data to the laser projector; and
the laser projector projecting an image relevant to the image data onto at least one of a plurality of suitable display areas on at least one of a plurality of suitable display surfaces.
